(19) United States
(12) Patent Application Publication
(10) Pub. No.: US 2016/0261667 A1
(43) Pub. Date: Sep. 8, 2016

(54) SYSTEMS AND METHODS OF MANAGING TIME ZONE INFORMATION

(71) Applicant: LeGuard, Inc., McLean, VA (US)

(72) Inventor: Anthony Clark LEWANDOWSKI, Herndon, VA (US)

(21) Appl. No.: 15/062,412

(22) Filed: Mar. 7, 2016

Related U.S. Application Data
(60) Provisional application No. 62/129,324, filed on Mar. 6, 2015.

(51) Int. Cl. H04L 29/08; H04L 29/06

(52) U.S. Cl. CPC H04L 67/02; H04L 67/42

(57) ABSTRACT

Systems, methods, and devices of the various embodiments enable management of time zone information among devices. A processor of a web server in a web server time zone (i.e., a first time zone) may receive a data set created at a communication device and a client time zone (i.e., a second time zone), wherein the data set includes an indication of the second time zone. The processor of the web server may parse the data sent to extract the indication of the second time zone. The processor of the web server may process the data set in the web server using an indication of the client time zone so as to simulate the client time zone in the web server, and thereby cause the data set to be processed as if it were in the client time zone.

### RELATED APPLICATIONS

The present application claims priority to U.S. Provisional Patent Application No. 62/129,324 entitled “Systems and Methods of Managing Time Zone Information” filed Mar. 6, 2015, the entire contents of which are hereby incorporated by reference.

### BACKGROUND

Billing systems typically collect data from users and record the data in a central location, such as a server. Such billing systems are used by professionals in many areas. Architects, consultants of all types and lawyers, to name but a few, typically use such systems and report on a periodic basis (monthly, weekly, quarterly etc.) on the activities performed on behalf of a client.

For example, billing systems geared for use by a law firm will typically collect an amount of time an attorney works on a case and a description of what work was performed. The data collected from all users (attorneys, paralegals, and support staff) may be manipulated to provide a record of the time spent by individuals and/or an organization on a particular project matter or on work for a particular client. These systems thus provide an after-the-fact view of the amount of time spent on any particular matter.

Managing time spent by workers in a geographically diverse and mobile workforce poses technical challenges. Work may be performed in a first time zone, and data about the work performed may be sent to a time a billing system in a different, second time zone. Worker mobility adds an additional potential challenge. For example, work may be performed in a first time zone, data about the work performed may be sent from a different, second time zone, and the receiving time and billing system may be located in a third time zone that is different from the first and second time zones. Accurate processing of data sets created and processed in different time zones is important to such enterprises.

### SUMMARY

Systems, methods, and devices of the various embodiments enable management of time zone information among devices. A processor of a web server in a client time zone (i.e., a second time zone), wherein the data set includes an indication of the second time zone. The processor of the web server may parse the data sent to extract the indication of the second time zone. The processor of the web server may process the data set in the web server using an indication of the client time zone so as to simulate the client time zone in the web server, and thereby cause the data set to be processed as if it were in the client time zone.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a component block diagram of a communication system suitable for use with the various embodiments.

FIG. 2 is a component block diagram of a server for use with the various embodiments.

FIG. 3 is a component block diagram of a communication device for use with the various embodiments.

FIG. 4 is a process flow diagram illustrating an embodiment method for managing time zone information of data sets of a web-based application across a plurality of time zones.

FIG. 5 is a message flow and operations diagram illustrating an embodiment method for managing time zone information of data sets of a web-based application across a plurality of time zones.

FIG. 6 is a component diagram of an example mobile device suitable for use with the various embodiments.

FIG. 7 is a component diagram of an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The various embodiments provide methods, and devices configured to implement the methods, for managing time zone information of data sets of a web-based application across a plurality of time zones. The various embodiments may be particularly useful for mobile work forces in which data about work performed by the mobile work force is performed and recorded in one time zone and processed in a second time zone.

The word “exemplary” is used herein to mean “serving as an example, instance, or illustration.” Any implementation described herein as “exemplary” is not necessarily to be construed as preferred or advantageous over other implementations.

The term “communication device” is used herein to refer to any one or all of cellular telephones, smartphones, personal or mobile multi-media players, personal data assistants (PDAs), laptop computers, tablet computers, smartbooks, palmtop computers, wireless electronic mail receivers, multimedia Internet enabled cellular telephones, wireless gaming controllers, and similar electronic devices and portable computing platforms which include a programmable processor and a memory.

The terms “component,” “module,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

As used herein the term “server” refers to any computing device capable of functioning as a server, such as a master exchange server, web server, mail server, document server, content server, or any other type of server. A server may be a dedicated computing device or a computing device including a server module (e.g., running an application that may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device thereby enabling it to function as an Internet server (e.g., an enterprise e-mail server) only to the extent necessary to provide the functionality described herein.

The various embodiments provide methods, and devices configured to implement the methods, for managing time zone information of data sets of a web-based application across a plurality of time zones. The various embodiments may be particularly useful for mobile work forces in which data about work performed by the mobile work force is performed and recorded in one time zone and processed in a second time zone.

Accurate processing of data sets created and processed in different time zones is important to geographically diverse businesses. Wide area communication networks, such as the Internet, enable rapid global communication that enables a business to provide services to its workforce nearly anywhere. The business may deploy an application server in communication with a wide area communication network to provide services to the workforce. The business may also deploy a web server, in communication with the application server, to enable the provision of the services using a web-based interface. The web server may thus process data and objects received from geographically diverse workers interacting with the web-based interface, some of whom may be in a time zone other than the time zone of the web server or the application server.

Processing data sets received by a web-based application to maintain consistency of time-sensitive records, such as time and billing records, poses certain technical challenges. A user may access the web server using a web browser or similar software on a communication device. The web server may send information to the web browser using a message or “page” encoded in a markup language, such as hypertext markup language (HTML) or extensible markup language (XML), etc., that is decoded and executed or rendered by the web browser on the communication device. For example, a web browser may execute received HTML code to render a web page on the display of a communication device. The web browser of the communication device may enable the user of the communication device to interact with the rendered message or page, for example by filling in form fields, clicking buttons, etc. The communication device may communicate data (e.g., text entered into form fields) from the rendered message or page and/or state information about the rendered message or page (e.g., button click indications) through post backs to the web server. In a post back, the data or state information may be input by the web browser into the encoded markup language of the message or page (e.g., re-encoded into the HTML page by the web browser), and the inputted data may be posted (i.e., sent) as a updated message or page (e.g., a new web page) to the web server. For example, Java scripts embedded in a web page may cause the web browser to perform a post back of data, such as time and billing information, to the web server in response to a button selection event (e.g., clicking of start or stop timer button) in the web page. The web server may receive the updated message or page from the web browser of the communication device and parse the updated message or page to extract the added data or state information, such as the time and billing information, from the page.

In current systems, to process the received posted back message or page (e.g., the HTML page with date and/or state information, such as time and billing information, encoded by and sent from the web browser of the communication device), the web server may create a process or thread in the time zone of the web server without taking into account the time zone of the web browser that sent the page to the web server. Processing web pages for an application, such as a time and billing system, in this way may cause confusion and inconsistency of data sets (e.g., time and billing records) because the communication device posting back the messages or pages may not be operating in the same time zone as the web server processing the posted back messages or pages.

In the various embodiments, to maintain consistency of records, the application code executing on the web server may be configured to process messages or pages it receives from communications devices in different time zones than the web server as if the web server were in the same time zone as each communication device posting back the messages or pages. In the various embodiments, the application code executing on the web server may be configured to extract time zone information from each page that it receives from a web browser. The application code may be further configured to use that time zone information in each related process and/or thread that the web server generates to process the received web page. Thus, the application code may process each received page as if the web server were located in the same time zone as each communication device that sends a page to the web server. The web server may process numerous simultaneous processes and/or threads, operating on each process or thread in the time zone of the web browser that sent the related page to the web server.

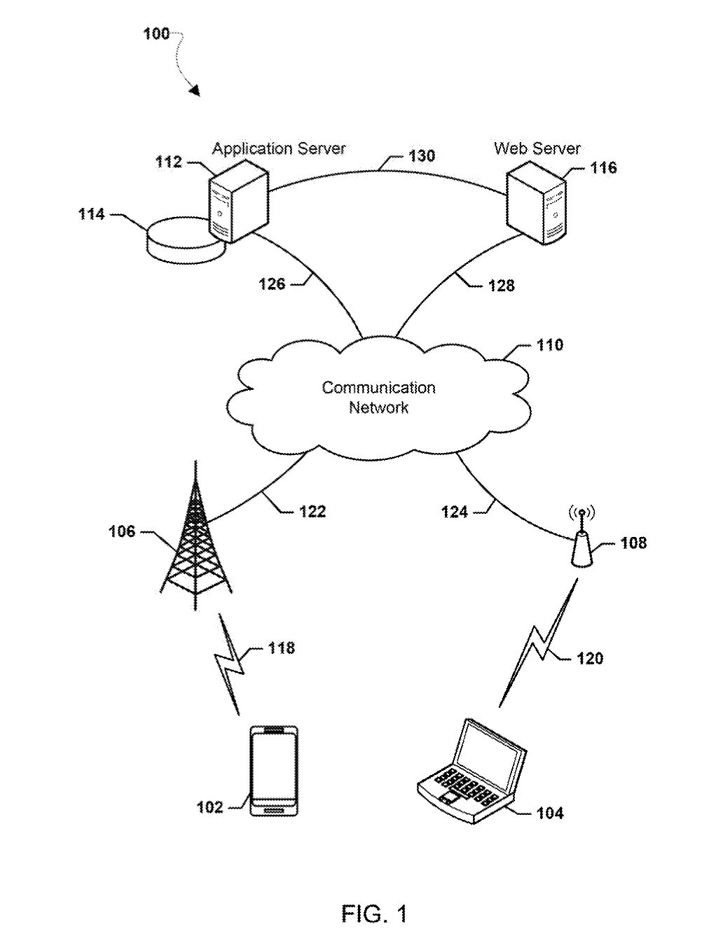

The various embodiments may be implemented in a variety of servers that send and receive data sets over a communication system, an example of which is illustrated in FIG. 1. Referring to FIG. 1, a communication system 100 may include communication devices such as communication devices 102 and 104, a base station 106, an access point 108, a communication network 110, an application server 112, and a web server 116. The base station 106 may communicate with the communication network 110 over a wired or wireless communication link 112, and the access point 108 may communicate with the communication network 110 over a wired or wireless communication link 124. The communication links 122 and 124 may include fiber optic backhaul links, microwave backhaul links, and other communication links. In some embodiments, the communication network 110 may include the Internet and/or other networks such as a mobile telephony communication network. The communication device 102 may communicate with the base station 106 over a wired or wireless communication link 118. The communication device 104 may communicate with the access point 108 over a wired or wireless communication link 120. The communication links 118 and 120 may include wireless communication links that use one or more radio access technologies, such as examples of radio access technologies may include LTE, Worldwide Interoperability for Microwave Access (WiMAX), Code Division Multiple Access (CDMA), Time Division Multiple Access (TDMA), Wideband CDMA (WCDMA), GSM, a radio access protocol in the IEEE 802.11 family of protocols (e.g., Wi-Fi), and other radio access technologies. The communication links 118 and 120 may also include wired communication links using one or more wired communication protocols.

The communication network 110 may include a wired and/or wireless communication network, and may include processing nodes, routers, gateways, and physical and/or wireless data links for carrying data among various network elements, including combinations thereof, and can include a local area network, a wide area network, and an internetwork (including the Internet). The communication network 110 may carry data to support communications by the communication devices 102 and 104. Wireless network protocols may include code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev.A, Worldwide Interoperability for Microwave Access (WiMAX), and Third Generation Partnership Project Long Term Evolution (3GPP LTE). Wired network protocols that may be utilized by the communication network 110 include Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). The communication network 110 may also include a wireless network, including base stations, wireless communication nodes, telephony switches, internet routers, network gateways, computer systems, communication links, or some other type of communication equipment, and combinations thereof.

The application server 112 may be a network element in communication with the communication network 110 over a communication link 126, and may include a server processor and associated circuitry to execute or direct the execution of processor-executable or server-executable instructions to provide an application or service to the communication devices 102 and 104. The application server 112 may communicate with storage devices such as a database 114 to store records and other data to provide the application or service. An example of the application/service may be a billing service, or a time and billing service, which may be configured to track and process data sets of work performed by a geographically diverse and mobile workforce. The application server 112 may retrieve and execute software from storage, which may include a disk drive, flash drive, memory circuitry, or some other memory device, and which can be local or remotely accessible. The software may include computer programs, firmware, or some other form of machine-readable instructions, and may include an operating system, utilities, drivers, network interfaces, applications, or some other type of software, including combinations thereof The application server 112 may receive instructions and other input from a user interface. Examples of the application server 112 may include a standalone computing device, a computer system, or a network component, and can be accessible, for example, by a wired or wireless connection, or through an indirect connection such as through a computer network or communication network.

The web server 116 may be a network node or network element in communication with communication network 110 over a communication link 128, and may include a processor and associated circuitry to execute or direct the execution of processor-executable instructions to send, receive, generate, and process web pages to enable the provision of the application or service to the communication devices 102 and 104 through a web-based interface. The web server 116 may communicate with the application server 112 over a communication link 130 and/or via the communication network 110.

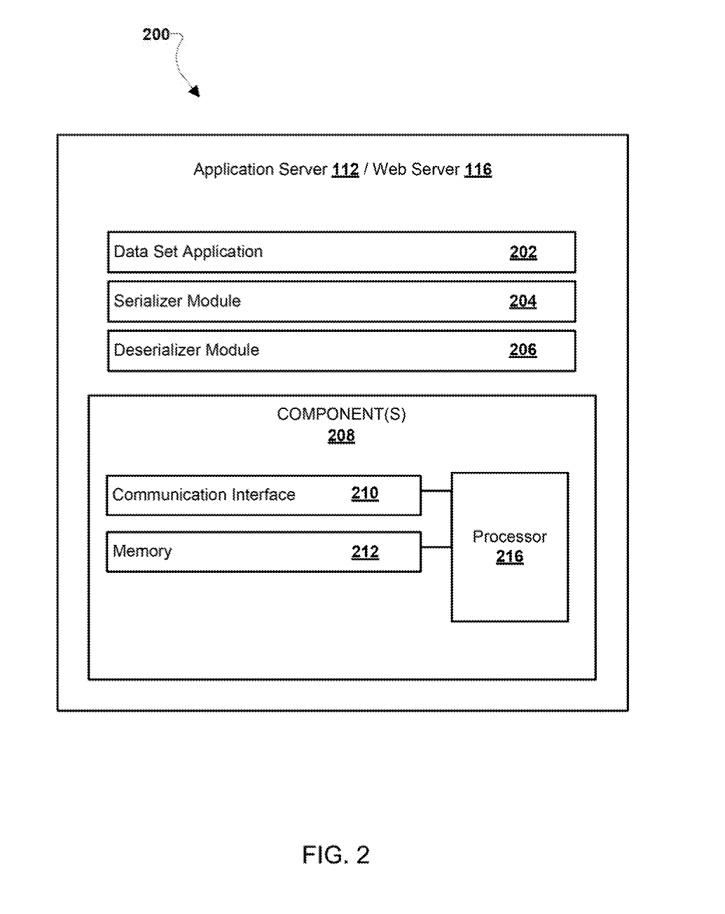

FIG. 2 illustrates a server 200 suitable for use with the various embodiments. The components described with respect to the server 200 may be used in an application server or a web server (e.g., the application server 112 and the web server 116 of FIG. 1). The server 200 may include various components 208, including a communication interface 210, and a memory 212. The communication interface 210 may enable the server 200 to communicate with another device, such as another network element. The memory 212 may include a non-transitory storage medium such as a disk drive, a flash drive, a solid state memory device, a memory circuitry, or some other memory device, in various forms of volatile and non-volatile memory storage, and may store processor-executable instructions, such as an operating system, computer programs, firmware, or some other form of processor-executable instructions, which may include an operating system, utilities, drivers, network interfaces, applications, or some other type of software. The server processor 216 may control the operation of the communication interface 210 and the memory 212.

The server 200 may execute instructions that provide a data set application 202, a serializer module 204, and a deserializer module 206. The data set application may include processor-executable instructions to provide an application or service to communication devices (e.g., the communication devices 102 and 104 of FIG. 1) over a communication system (e.g., the communication system 100 of FIG. 1). The server executing the serializer module 204 and the deserializer module 206 may operate to encode and decode, respectively, information received by the server 200. The server executing the deserializer module 206 may decode received information to enable processing the information by the server 200. The server executing the serializer module 204 may encode processed information for transmission to another network element via the communication interface 210.

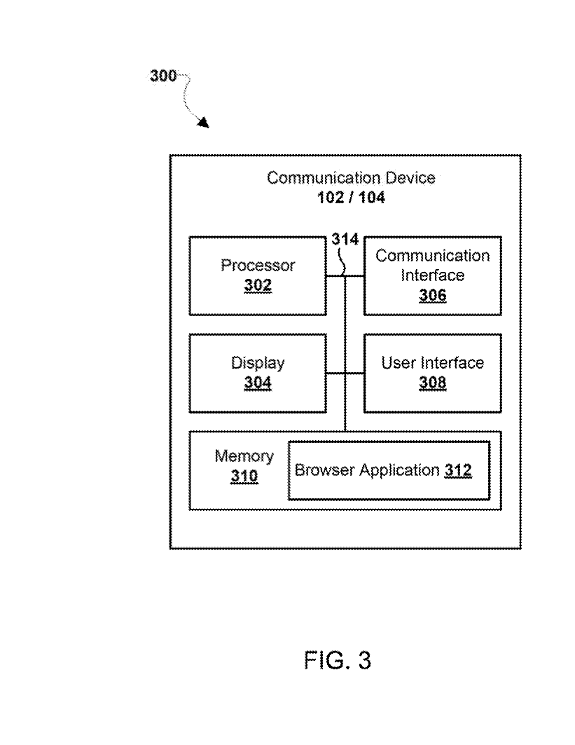

FIG. 3 illustrates a communication device 300 suitable for use with the various embodiments. The components described with respect to the communication device 300 may be used in a communication device (e.g., the communication devices 102 and 104 of FIG. 1) and may enable communication with a server (e.g., the server 200 of FIG. 2). The communication device 300 may include a processor 302, a display 304, a communication interface 306, a user interface 308, and a memory 310. The memory 310 may include a non-transitory storage medium such as a disk drive, a flash drive, a solid state memory device, a memory circuitry, or some other memory device, in various forms of volatile and non-volatile memory storage, and may store processor-executable instructions, such as an operating system, computer programs, firmware, or some other form of processor-executable instructions, which may include an operating system, utilities, drivers, network interfaces, applications, or some other type of software. The display 304 may display information, and may be coupled with the user interface 308 to receive input, such as by a touch screen or similar device. The communication interface 306 may include various elements to enable the communication device 300 to communicate with another device and/or with a communication network (such as the communication network 100 of FIG. 1), including interfaces, transceivers, and other hardware and/or related software. The processor 302 may control the operation of the display 304, the communication interface 306, the user interface 308, and the memory 312, over a communication link 314 such as a bus or other communication link. The memory 310 may store a browser application 312. The browser application 312 may enable the communication device 300 to communicate with a web server (e.g., the web server 116 of FIG. 1).

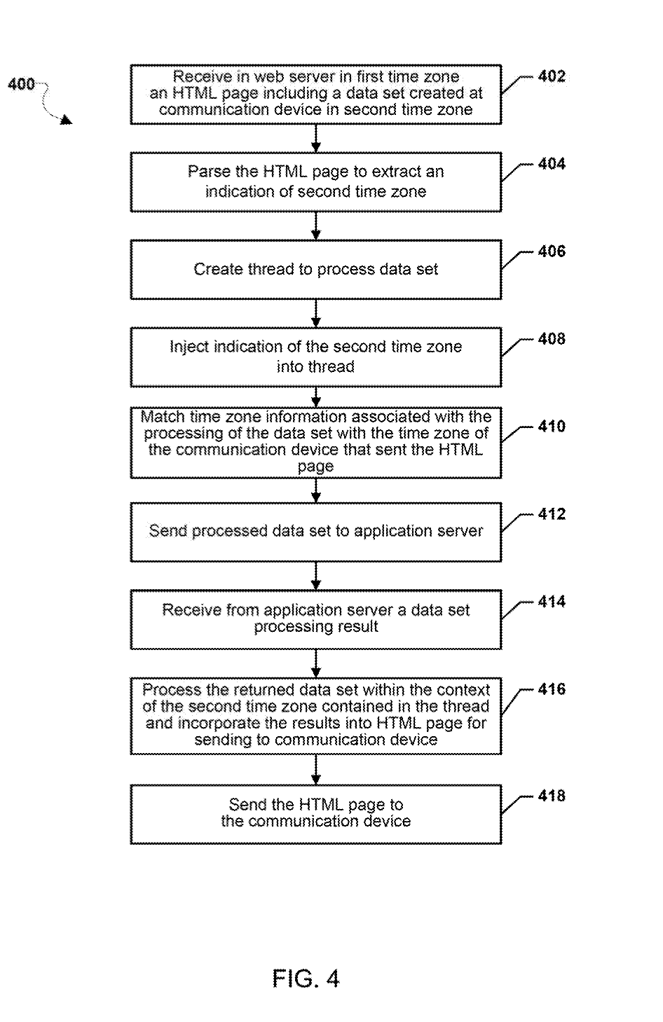

FIG. 4 illustrates a method 400 for managing time zone information of data sets of a web-based application across a plurality of time zones according to various embodiments. The method 400 may be implemented by a processor in a server (e.g., the processor 216 of the server 200 in FIG. 2) and/or in a processor of a communication device (e.g., the processor 302 of the communication device 300 in FIG. 3). In block 402, a processor of a web server that is located in a first time zone may receive an HTML page that includes a data set created at a communication device in a second time zone. For example, the communication device and the second time zone may communicate with the web server to access a web-based service provided by an application server via the web server. To provide a data set to the application server related to the service running on the application server, a web browser application running on the communication device may create the HTML page, which may include a data set for use by the application server. The data set may include, for example, time and billing information for a service running on the application server. The data set and/or the HTML page may also include an indication of the second time zone in which the communication device is located. In some embodiments, the indication of the second time zone may include a data object created by the communication device. The data object may encapsulate date, time, and/or time zone information of the location of the communication device. In some embodiments, the web browser running on the communication device may include the data object in the HTML page. The communication device may send the HTML page to the web server, thereby posting back the HTML page to the web server including the data set created at the communication device in the second time zone.

In block 404, the processor of the web server may parse the received HTML page to extract the indication of the second time zone in which the communication device is located. In some embodiments, the processor of the web server may parse the data object from the HTML page to extract the indication of the second time zone. The processor of the web server may also extract the data set from the HTML page.

In block 406, the processor of the web server may create a thread to process the data set. In some embodiments, in order to process the data sent, the processor of the web server may create a process, which may include one or more threads, to perform operations on the data set. In an embodiment, the time zone information may be transferred to all threads created from a master thread. In block 408, the processor of the web server may inject the indication of the second time zone into each thread created to process the data set. In block 410, the processor of the web server may match time zone information associated with the processing of the data set with the time zone of the web browser and/or communication device that sent the HTML page including the data set to the web server. In block 412, the web server may send the processed data set to the application server.

In block 414, the web server may receive from the application server a data set processing result. The data set processing result may be data that is sent by the application server resulting from or responsive to processing the data set by the application server. In block 416, the web server may process the returned data set within the context of the second time zone contained in the thread and incorporate the results into the HTML page for sending to the communication device. In block 418, the web server may send the HTML page to the communication device.

In some embodiments, the processor of the web server may extract the indication of the second time zone at a low level of a software stack. For example, application software running on the processor of the web server may process the data set and the indication of the second time zone at a software stack level at which an operating system of the web server interacts with (e.g., handshakes with) the application software. In some embodiments, the processing of the indication of the second time zone may be performed at a low level of a .NET framework. The operations for processing the indication of the second time zone at the low level of the software stack may be made available to other higher-level applications, such as web applications, through a software abstraction layer, such as an application programming interface (API). Use of an abstraction layer to provide access to the operations processing the indication of the second time zone may reduce the complexity of such higher-level applications, and further may reduce the potential for bugs in such higher-level applications.

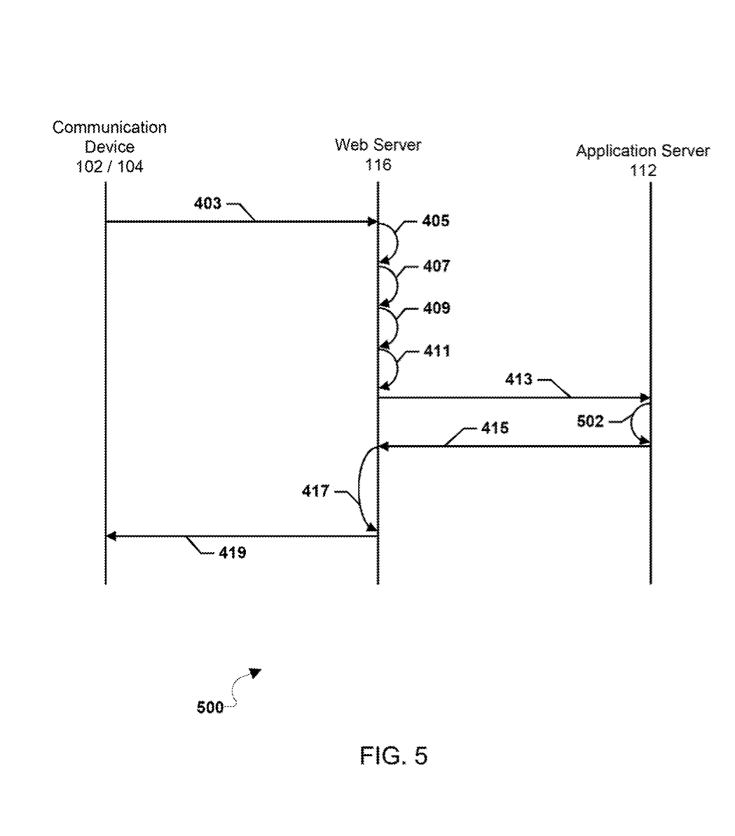

FIG. 5 illustrates message flows and operations for managing time zone information of data sets of a web-based application across a plurality of time zones according to various embodiments. The method 500 may be implemented by a processor in a server (e.g., the processor 216 of the server 200 in FIG. 2) and/or in a processor of a communication device (e.g., the processor 302 of the communication device 300 in FIG. 3). A processor of a web server that is located in a first time zone may receive an HTML page 403 that includes a data set created by a communication device in a second time zone. The processor of the web server may parse the HTML page 405 to extract an indication of the second time zone in which the communication device is located. The processor of the web server may create a thread to process the data set in operation 407. In some embodiments, in order to process the data sent, the processor of the web server may create a process, which may include one or more threads, to perform operations on the data set. The processor of the web server may inject the indication of the second time zone into the thread created to process the data set in operation 409. The processor of the web server may match time zone information associated with the processing of the data set with the time zone of the web browser and/or communication device that sent the HTML page including the data set to the web server in operation 411. The web server may then send the processed data set in a message 413 to the application server. The application server may perform one or more processing operations 502 on the processed data set.

The web server may subsequently receive from the application server a data set processing result message 415, which may result from or be responsive to processing the data set by the application server. The web server may then inject the indication of the second time zone into the HTML page that results from the processing of the data set processing result in operation 417, and the web server may then send the HTML page 419 to the communication device.

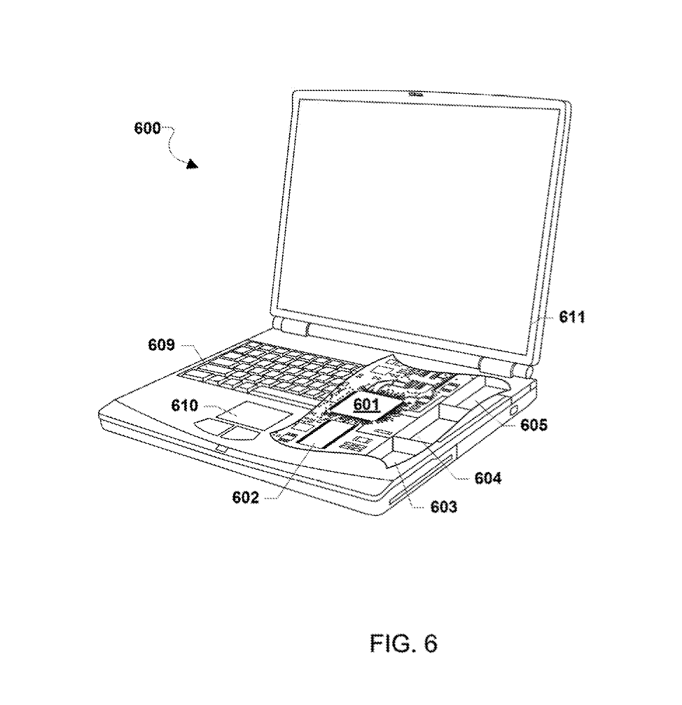

FIG. 6 is a component block diagram of a communication device 600 suitable for implementing various embodiments, for instance, some or all of the methods illustrated in FIGS. 4 and 5. The communication device 600 generally includes a processor 601 coupled to volatile memory 602 and a large capacity nonvolatile memory, such as a disk drive 603. The communication device 600 may also include a compact disc (CD) and/or DVD drive 604 coupled to the processor 601. The communication device 600 may also include a number of connector ports coupled to the processor 601 for establishing data connections or receiving external memory devices, such as a network connection circuit 605 for coupling the processor 601 to a network. The computer 600 may further be coupled to a keyboard 609, a pointing device such as a mouse or trackpad 610, and a display 611, as is well known in the computer arts.

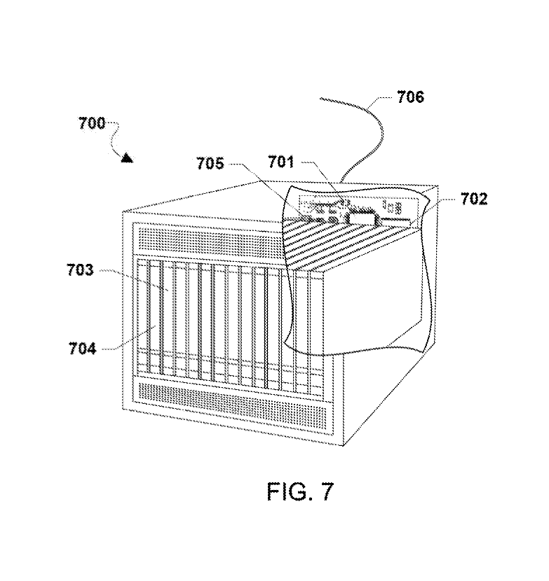

The various embodiments may also be implemented on any of a variety of commercially available server devices, such as the server 700 illustrated in FIG. 7. Such a server 700 typically includes a processor 701 coupled to volatile memory 702 and a large capacity nonvolatile memory, such as a disk drive 703. The server 700 may also include a floppy disc drive, compact disc (CD) or DVD disc drive 704 coupled to the processor 701. The server 700 may also include network access ports 706 coupled to the processor 701 for establishing network interface connections with a network 707, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

The processors 601 and 701 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory 602 and 702 before they are accessed and loaded into the processors 601 and 701. The processors 601 and 701 may include internal memory sufficient to store the application software instructions. In many devices the internal memory may be a volatile or nonvolatile memory, such as flash memory, or a mixture of both. For the purposes of this description, a general reference to memory refers to memory accessible by the processors 601 and 701 including internal memory or removable memory plugged into the device and memory within the processor 601 and 701 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In various embodiments, the functions described may be implemented in hardware, software, firmware, or any combination thereof If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for managing time zone information of a data set of a web-based application across a plurality of time zones, comprising:
receiving, in a web server in a web server time zone, a data set created by a communication device in a client time zone, wherein the data set comprises an indication of the client time zone;
parsing, in the web server, the data set to extract the indication of the client time zone; and
processing the data set in the web server using the indication of the client time zone such that the client time zone is simulated in the web server.

2. The method of claim 1, wherein processing the data set in the web server comprises the web server:
creating a thread to process the data set;
injecting the indication of the client time zone into the thread; and
processing the data set using the thread including the injected indication of the client time zone.

3. The method of claim 2, further comprising the web server:
sending the processed data set to an application server;
receiving from the application server a data set processing result;
processing the data set processing result for sending to the communication device; and
sending the data set processing result to the communication device in the client time zone.

4. The method of claim 3, wherein processing the data set processing result for sending to the communication device comprises the web server:
processing the data set processing result into an HTML page;
injecting the indication of the client time zone into the HTML page; and
sending the HTML page including the indication of the client time zone to the communication device.

5. The method of claim 1, wherein processing the data set in the web server further comprises the web server:
creating an object using the indication of the client time zone;
processing the data set into an application server format; and
sending the object and the data set to an application server in the application server format.

6. The method of claim 1, wherein the data set is received by the web server from a web browser application running on the communication device.

7. The method of claim 6, wherein the data set is included in an HTML page from the web browser application running on the communication device, and wherein parsing, in the web server, the data set comprises extracting the data set and the indication of the client time zone from the HTML page.

8. A web server in a web server time zone, comprising:
a processor configured with processor executable instructions to perform operations comprising:
receiving a data set created by a communication device in a client time zone, wherein the data set comprises an indication of the client time zone;
parsing the data set to extract the indication of the client time zone; and
processing the data set in the web server using the indication of the client time zone such that the client time zone is simulated in the web server.

9. The web server of claim 8, wherein the processor is configured with processor executable instructions to perform operations such that processing the data set in the web server comprises:
creating a thread to process the data set;
injecting the indication of the client time zone into the thread; and
processing the data set using the thread including the injected indication of the client time zone.

10. The web server of claim 9, wherein the processor is configured with processor executable instructions to perform operations further comprising:
sending the processed data set to an application server;
receiving from the application server a data set processing result;
processing the data set processing result for sending to the communication device; and
sending the data set processing result to the communication device in the client time zone.

11. The web server of claim 10, wherein the processor is configured with processor executable instructions to perform operations such that processing the data set processing result for sending to the communication device comprises:
processing the data set processing result into an HTML page;
injecting the indication of the client time zone into the HTML page; and
sending the HTML page including the indication of the client time zone to the communication device.

12. The web server of claim 8, wherein the processor is configured with processor executable instructions to perform operations such that processing the data set in the web server further comprises:
creating an object using the indication of the client time zone;
processing the data set into an application server format; and
sending the object and the data set to an application server in the application server format.

13. The web server of claim 8, wherein the data set is received by the web server from a web browser application running on the communication device.

14. The web server of claim 13, wherein the data set is included in an HTML page from the web browser application running on the communication device, and wherein the processor is configured with processor executable instructions to perform operations such that parsing the data set comprises extracting the data set and the indication of the client time zone from the HTML page.

15. A non-transitory processor readable medium having stored thereon processor executable instructions configured to cause a processor of a web server in a web server time zone to perform operations comprising:
receiving a data set created by a communication device in a client time zone, wherein the data set comprises an indication of the client time zone;
parsing the data set to extract the indication of the client time zone; and
processing the data set in the web server using the indication of the client time zone such that the client time zone is simulated in the web server.

16. The non-transitory processor readable medium of claim 15, wherein the stored processor executable instructions are configured to cause a processor of the web server to perform operations such that processing the data set in the web server comprises:
creating a thread to process the data set;
injecting the indication of the client time zone into the thread; and
processing the data set using the thread including the injected indication of the client time zone.

17. The non-transitory processor readable medium of claim 16, wherein the stored processor executable instructions are configured to cause a processor of the web server to perform operations further comprising:
sending the processed data set to an application server;
receiving from the application server a data set processing result;
processing the data set processing result for sending to the communication device; and
sending the data set processing result to the communication device in the client time zone.

18. The non-transitory processor readable medium of claim 17, wherein the stored processor executable instructions are configured to cause a processor of the web server to perform operations such that processing the data set processing result for sending to the communication device comprises:
processing the data set processing result into an HTML page;
injecting the indication of the client time zone into the HTML page; and
sending the HTML page including the indication of the client time zone to the communication device.

19. The non-transitory processor readable medium of claim 15, wherein the stored processor executable instructions are configured to cause a processor of the web server to perform operations such that processing the data set in the web server further comprises:
creating an object using the indication of the client time zone;
processing the data set into an application server format; and
sending the object and the data set to an application server in the application server format.

20. The non-transitory processor readable medium of claim 15, wherein the stored processor executable instructions are configured to cause a processor of the web server to perform operations such that:
the data set is received by the web server from a web browser application running on the communication device;
the data set is included in an HTML page from the web browser application running on the communication device; and
parsing the data set comprises extracting the data set and the indication of the client time zone from the HTML page.
